(19) United States
(12) Patent Application Publication
(10) Pub. No.: US 2013/0285567 A1
(43) Pub. Date: Oct. 31, 2013

(54) Light-Emitting Device and Luminaire

(71) Applicant: TOSHIBA LIGHTING & TECHNOLOGY CORPORATION, Yokosuka-shi (JP)

(72) Inventors: Hiroya Kan, Yokosuka-shi (JP); Kiyoteru Kosa, Yokosuka-shi (JP); Naoko Iwai, Yokosuka-shi (JP); Makoto Kono, Yokosuka-shi (JP); Takao Kowada, Yokosuka-shi (JP); Kazumi Aoki, Yokosuka-shi (JP)

(73) Assignee: TOSHIBA LIGHTING & TECHNOLOGY CORPORATION, Yokosuka-shi (JP)

(21) Appl. No.: 13/832,146

(22) Filed: Mar. 15, 2013

(30) Foreign Application Priority Data
Apr. 25, 2012 (JP) 2012-100004

(51) Int. Cl. H05B 33/08

(52) U.S. Cl. CPC H05B 33/0821
USPC 315/192

(57) ABSTRACT

According to one embodiment, a light-emitting device includes a light source section including a plurality of series circuits, in each of which a plurality of light-emitting elements are connected in series, the plurality of series circuits being connected in parallel, and a substrate on which the light-emitting elements of the light source section are mounted. The light-emitting elements of the series circuits different from one another are mounted adjacent to one another.

### CROSS-REFERENCE TO RELATED APPLICATIONS

This application is based upon and claims the benefit of priority from the prior Japanese Patent Application No. 2012-100004, filed on Apr. 25, 2012, the entire contents of which are incorporated herein by reference.

### FIELD

Embodiments described herein relate generally to a light-emitting device and a luminaire in which light-emitting elements are used.

### BACKGROUND

If series circuits, in each of which a plurality of light-emitting elements are connected in series, are connected in parallel to configure a light-emitting device, electric currents respectively flowing to the series circuits fluctuate according to fluctuation in a forward current (Vf) of the light-emitting elements.

In the light-emitting device of the related art, balancing resistors are used in the series circuits to suppress the fluctuation in the electric currents respectively flowing to the series circuits and suppress the fluctuation in the brightness of the light-emitting device.

However, in the light-emitting circuit of the related art, it is likely that an increase in costs is caused by use of the balancing resistors.

In some luminaire including the light-emitting elements as light sources, adjacent metal plates that support the light-emitting elements are arranged while being separated from each other.

### BRIEF DESCRIPTION OF THE DRAWINGS

FIG. 1 is a perspective view showing a luminaire according to an embodiment;

FIG. 2 is an exploded perspective view showing the luminaire;

FIG. 3 is a schematic plan view showing a cover member and a lighting circuit cover removed and viewed from below in the luminaire;

FIG. 4 is a sectional view showing the luminaire;

FIG. 5 is an enlarged view showing a range surrounded by a dotted line in FIG. 4;

FIG. 6 is a plan view showing a mounting state of light-emitting elements in the luminaire;

FIG. 7 is a connection diagram showing a connection state of the light-emitting elements of the luminaire; and

FIG. 8 is a sectional view showing a completion state of attachment of the luminaire to the ceiling surface.

### DETAILED DESCRIPTION

In view of the above circumstances, an embodiment provides a light-emitting device and a luminaire in which brightness fluctuation is suppressed.

According to one embodiment, a light-emitting device includes, a light source section including a plurality of series circuits, in each of which a plurality of light-emitting elements are connected in series, the plurality of series circuits being connected in parallel, and a substrate on which the light-emitting elements of the light source section are mounted. The light-emitting elements of the series circuits different from one another are mounted adjacent to one another.

### First Embodiment

A light-emitting device according to a first embodiment includes: a light source section including a plurality of series circuits, in each of which a plurality of light-emitting elements are connected in series, the plurality of series circuits being connected in parallel; and a substrate on which the light-emitting elements of the light source section are mounted. The light-emitting elements of the series circuits different from one another are mounted adjacent to one another.

### Second Embodiment

A light-emitting device according to a second embodiment includes a plurality of series circuits, in each of which a plurality of light-emitting element having a predetermined color temperature are connected in series. The light-emitting circuit includes: a first light source section in which the plurality of series circuits are connected in parallel; and a second light source section including a plurality of series circuits, in each of which a plurality of light-emitting elements having a color temperature different from the color temperature of the light-emitting elements of the first light source section are connected in series, the plurality of series circuits being connected in parallel. The light-emitting circuit includes a substrate on which the light-emitting elements of the first light source section and the light-emitting elements of the second light source section are mounted. The light-emitting elements of the series circuits different from one another of the light source sections different from each other are mounted adjacent to one another.

### Third Embodiment

A luminaire according to a third embodiment includes: a luminaire main body; and the light-emitting device according to the first embodiment or the second embodiment disposed in the luminaire main body.

According to the embodiments, it is possible to provide the light-emitting device and the luminaire that can suppress brightness fluctuation.

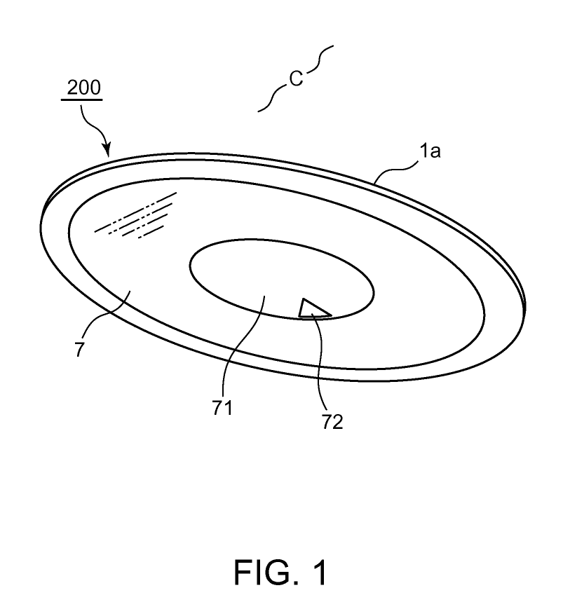

An embodiment is explained below with reference to FIGS. 1 to 8. In the figures, a wiring connection relation of lead wires and the like is sometimes omitted.

The same components are denoted by the same reference numerals and signs and redundant explanation of the components is omitted.

In FIG. 1, a luminaire 200, a luminaire main body 1a, a cover member 7, a decorative cover 71, a light-receiving window 72, and a ceiling C are shown.

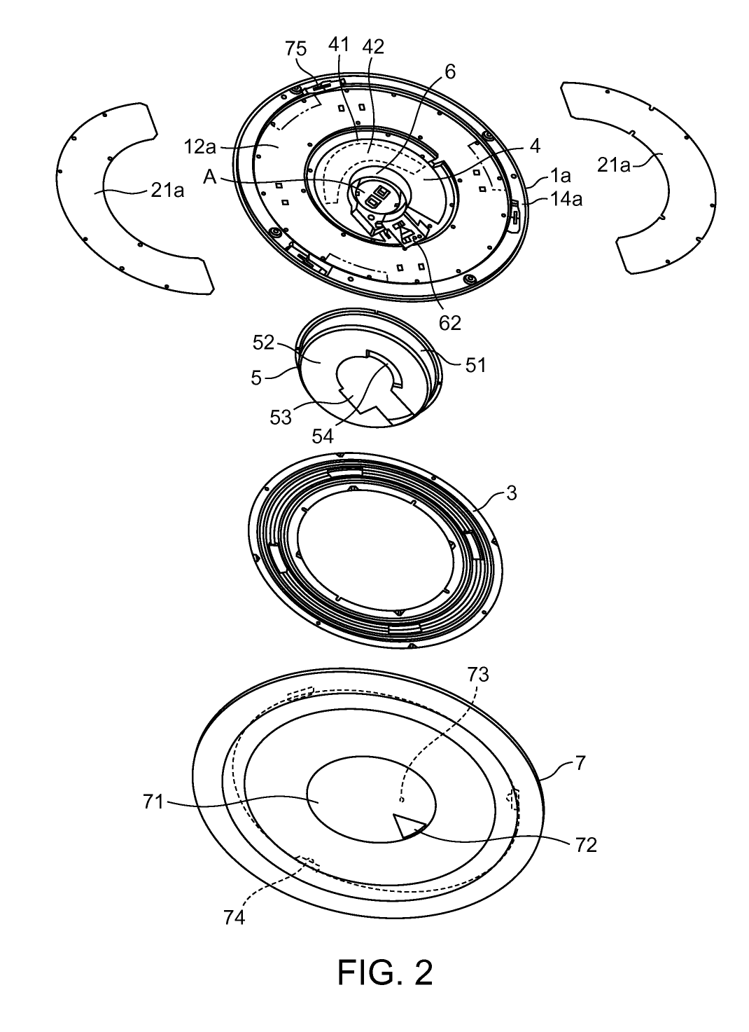

In FIG. 2, the luminaire main body 1a, a lighting circuit cover 5, a diffusing member 3, and the cover member 7 are shown.

The luminaire main body 1a shown in FIG. 2 includes a lighting circuit 4, an attaching section 6, a flat section 12a, a concave section 14a, a substrate 21a, a circuit board 41, circuit components 42, electric auxiliary components 62, a cover receiving member 75, and an adapter A.

The lighting circuit cover 5 shown in FIG. 2 includes a sidewall 51, a front wall 52, an opening section 53, and a guide concave section 54. In FIG. 2, a projecting pin 73 of the cover member 7 is shown.

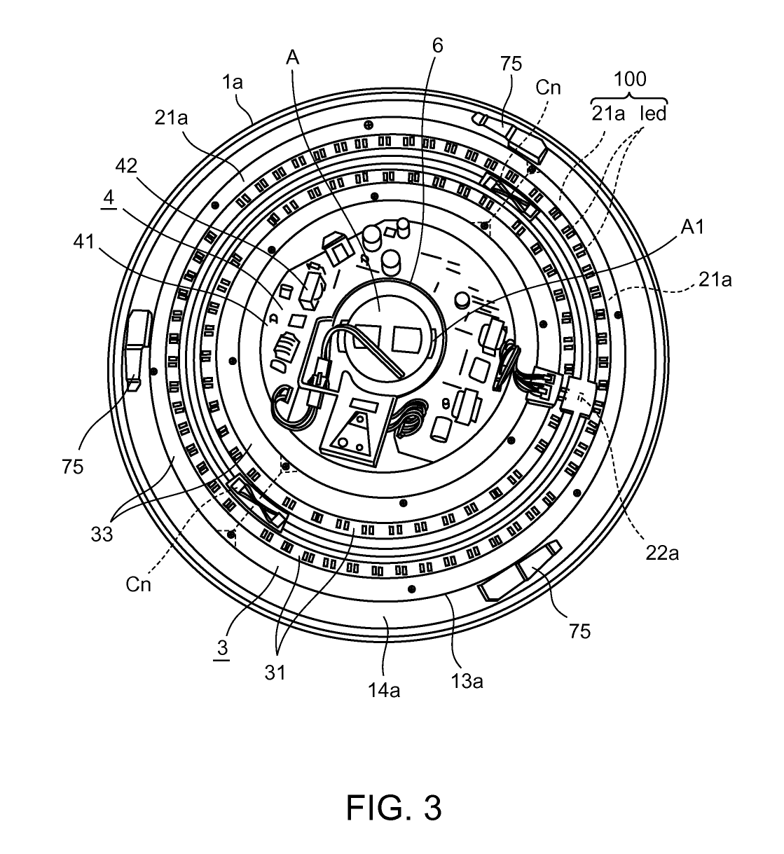

In FIG. 3, a light-emitting device 100 (light-emitting circuit) includes a substrate 21a and light-emitting elements led. In FIG. 3, a step section 13a, ridge sections 31, a flat section 33, locking sections A1, and a connector Cn are shown.

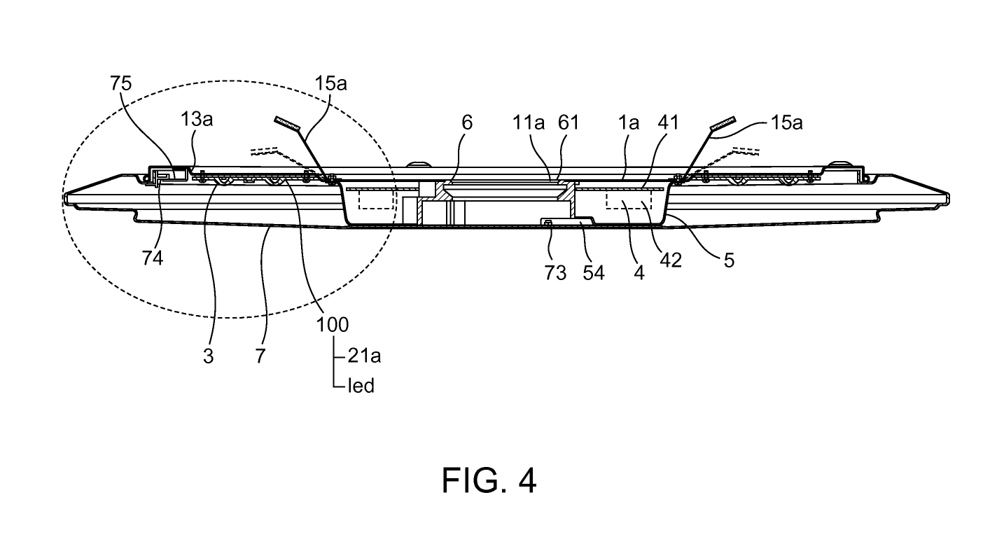

In FIG. 4, a circular opening 11a, spring members for luminaire attachment 15a, an engaging opening 61, and a cover attachment fitting 74 are shown.

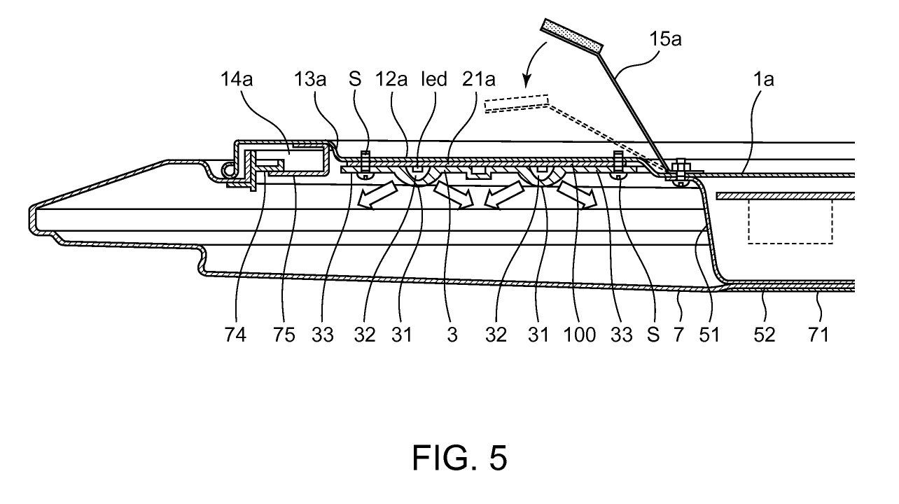

In FIG. 5, U-shaped grooves 32, the flat section 33, and screws S are shown.

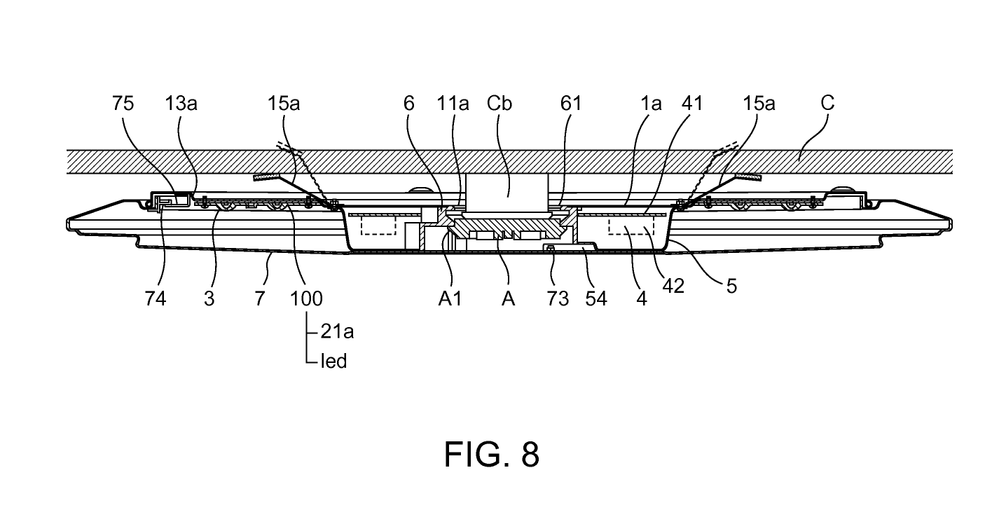

In FIG. 8, a wiring device Cb is shown.

The luminaire 200 according to this embodiment is a luminaire for general home use used while being attached to a ceiling hook body functioning as a wiring device arranged on a luminaire attaching surface. The luminaire 200 illuminates a room using light emitted from the light-emitting device 100 including a plurality of light-emitting elements led mounted on the substrate 21a. In this specification, “led” indicates the light-emitting element.

In FIGS. 1 to 4, the luminaire 200 includes the luminaire main body 1a, the light-emitting device 100, the diffusing member 3, the lighting circuit 4, the lighting circuit cover 5, the attaching section 6, and the cover member 7. The luminaire 200 includes the adapter A electrically and mechanically connected to the ceiling hook body Cb (explained below) set on the ceiling surface C functioning as the luminaire attaching surface. The luminaire 200 is formed in a rounded circular external appearance. The front surface side of the luminaire 200 is a light irradiation surface and the rear surface side of the luminaire 200 is an attaching surface to the ceiling surface C.

As shown in FIGS. 2 to 5, the luminaire main body 1a is a chassis formed in a circular shape from a flat plate made of a metal material such as cold rolled steel. Substantially in the center of the luminaire main body 1a, a circular opening 11a for disposing the attaching section 6 explained later is formed. On the outer circumferential side of the flat section 12a of the inner surface side on which the light-emitting circuit 100 is attached, the step section 13a leading to the rear surface side is formed and a gutter-like concave section 14a is formed. In the step section 13a, a cover receiving member to which the cover member 7 is detachably attached is arranged. More specifically, the cover receiving member is a cover receiving fitting 75. The cover receiving member is arranged in the concave section 14a formed by the step section 13a. Further, the spring members 15a for attaching the luminaire 200 are provided in four places on the rear surface side of the luminaire main body 1a. The spring members 15a are made of metal such as stainless steel and formed by bending a substantially rectangular leaf spring.

As shown in FIGS. 2 to 6, the light-emitting device 100 includes the substrate 21a and the plurality of light-emitting elements led mounted on the substrate 21a (in FIG. 2, the light-emitting elements led are not shown). The substrate 21a is formed by disposing two arcuate substrates 21a having a predetermined width dimension to be connected and is formed in a substantially circular shape as a whole. In actual, the substrate 21a formed in the substantially circular shape as a whole is composed of the two divided substrates 21a.

By using the substrate 21a divided as explained above, it is possible to absorb thermal expansion and contraction in a dividing section of the substrate 21a and suppress deformation of the substrate 21a. It is desirable to use the substrate 21a divided into a plurality of pieces. However, one substrate integrally formed in a substantially circular shape may be used.

The substrate 21a is formed of a flat plate made of glass epoxy resin, which is an insulating material. A wiring pattern is formed by a copper foil on the front surface side of the substrate 21a. A white resist layer acting as a reflecting surface is applied to the wiring pattern, i.e., the front surface of the substrate 21a. If the material of the substrate 21a is an insulating material, a ceramics material or a synthetic resin material can be applied. If the substrate 21a is made of metal, a base substrate made of metal formed by superimposing an insulating layer over the entire surface of a base plate having high thermal conductivity and excellent in heat radiation properties such as aluminum can be applied.

The light-emitting element led is an LED and is an LED package of a surface mounting type. A plurality of the LED packages are mounted in a plurality of rows, in this embodiment, in two rows on the inner circumferential side and the outer circumferential side along the circumferential direction of the circular substrate 21a, i.e., substantially on the circumference centering on the attaching section 6. As the LED packages, the LED packages, a light-emitting color of which is cool white N, and the LED packages, a light-emitting color of which is warm white L, are used. The LED packages are alternately or mixedly arranged. The light-emitting elements led adjacent to each other in the respective rows are disposed a predetermined space apart from each other.

The cool white may be, for example, about 5000 K and the warm white may be, for example, about 2000 to 3000 K.

The light-emitting elements led do not always need to be mounted in a plurality of rows. For example, the light-emitting elements led may be mounted in one row along the circumferential direction. The number of rows and the number of the light-emitting elements led can be appropriately set according to a desired output.

The LED package includes an LED chip disposed in a main body schematically formed of ceramics or synthetic resin and translucent resin for mold such as epoxy resin or silicone resin for sealing the LED chip. The LED chip is a blue LED chip that emits blue light. A phosphor is mixed in the light-transmissive resin in order to enable the LED package to emit cool white light and warm white light. In the main body, an electrode on an anode side and an electrode on a cathode side connected to the LED chip are provided.

A light-emitting element 22a for a night-light is mounted on a specific substrate 21 (in FIG. 3, the right side). As the light-emitting element 22a, an LED package same as an LED package for warm color in a main light source mounted in a circular shape is used.

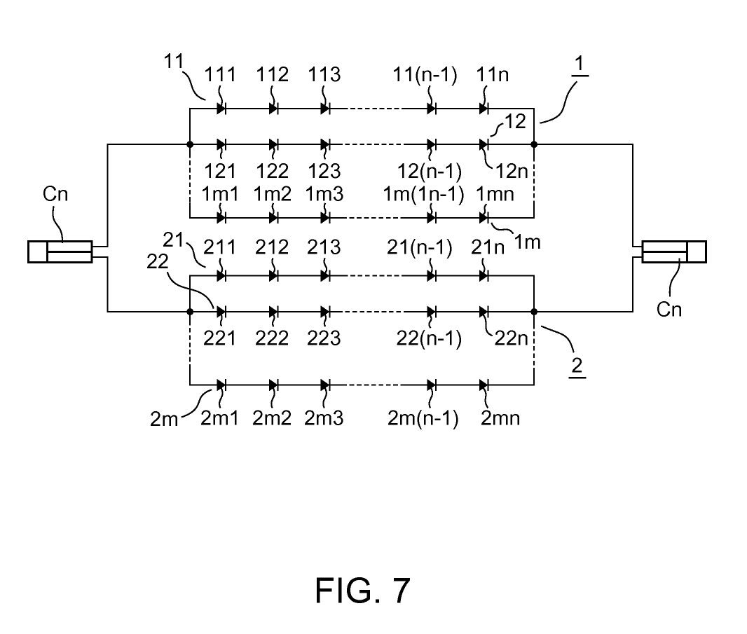

FIG. 7 shows a connection state of the light-emitting elements led in one piece of substrate 21a. The light-emitting device 100 includes a first light source section 1 including the light-emitting elements led for an N color (cool white N) and a second light source section 2 including the light-emitting elements led for an L color (warm white L). The first light source section 1 includes m series circuits in which n light-emitting elements led are connected in series. The series circuits are referred to as series circuits 11, 12, . . . , and 1m (a number of the second digit from the last and a number of the last digit respectively represent that the series circuits are the series circuits of the first light source section 1 and which series circuits from the top in the first light source section 1 the series circuits are. For example, a sign of the fifth series circuit of the first light source section 1 is 15). In the first light source section 1, the respective series circuits 11, 12, . . . , and 1m are connected in parallel to one another. In the series circuit 11, the light-emitting element led on a highest potential side is referred to as light-emitting element 111 and the light-emitting element led on the next highest potential side is referred to as light-emitting element 112. Similarly, an nth (a lowest potential side) light-emitting element led is referred to as light-emitting element 11n (a number of the third digit from the last, a number of the second digit from the last, and a number of the last digit of the sign of the light-emitting element led respectively represent that the series circuit 11 is the series circuit of the first light source section 1, which series circuit from the top in the first light source section 1 the series circuit 11 is, and which light-emitting element led counted from the high potential side in the series circuit the light-emitting element led is. For example, a sign of the fifth light-emitting element led from the high potential side of the fifth series circuit of the first light source section 1 is 155). In the second light source section 2, signs of the series circuits, i.e., signs of the series circuits 21, 22, . . . , and 2m and the light-emitting elements led are given according to the same rules.

Specifically, the light-emitting device 100 includes two light source sections, i.e., the first light source section and the second light source section, in which four series circuits, in each of which six light-emitting elements led are connected in series, are connected in parallel. That is, n=6 and m=4. Therefore, forty-eight light-emitting elements led in total are connected. Further, ends of two lines are connected to the connectors Cn to be capable of being connected to a connector of the substrate 21a or a connector on the power supply side.

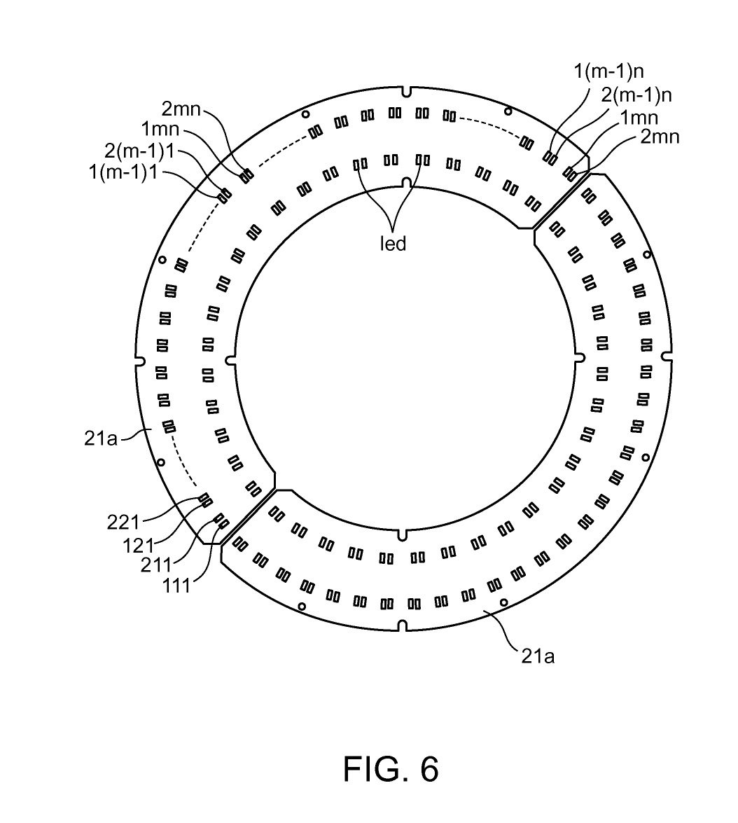

Mounting of the light-emitting elements led on the substrate 21a is explained with reference to FIG. 6.

As shown in FIGS. 6 and 7, the light-emitting elements led of the series circuits different from one another of the light source sections different from each other are mounted on the substrate 21a adjacent to one another. On the substrate 21a, the light-emitting elements led are mounted in order of light-emitting elements 111, 211, 121, 221, and the like. As explained above, the light source sections and the series circuits to which the light-emitting elements 111, 211, 121, 221, and the like belong are different among the light-emitting elements led adjacent to one another.

The light-emitting elements led are sequentially mounted in the circumferential direction on the substrate 21a. First, the light-emitting elements led on the highest potential side in the series circuits are mounted. That is, the light-emitting elements led are mounted in order from the light-emitting elements led, the numbers of the last digits of the signs of which are “1”. Among the light-emitting elements led, the numbers of the last digits of the signs of which are “1”, the light-emitting elements led, the numbers of the second digits from the last of the signs of which are small numbers, are mounted earlier. That is, the light-emitting elements led are mounted in order of the numbers of the second digits from the last of the signs of the light-emitting elements, i.e., 1, 2, 3, 4, . . . , (m−1), and m. Further, the light-emitting elements led are mounted on the substrate 21a in order of the numbers of the third digits from the last of the signs of the light-emitting elements, i.e., 1, and 2. That is, the light-emitting elements led belonging to the first light source section are mounted on the substrate 21a earlier.

The diffusing member 3 is a lens member. The diffusing member 3 is made of transparent synthetic resin having insulation properties such as polycarbonate or acrylic resin. As representatively shown in FIG. 5, the diffusing member 3 is integrally formed in a substantially circular shape along the arrangement of the light-emitting elements led and disposed to cover the entire surface of the substrate 21a including the light-emitting elements led.

In the lens member, in an inner circumferential side portion and an outer circumferential side portion having a substantially circular shape, the ridge sections 31 having a two-ridge mountain shape in the circumferential direction and having a fixed sectional shape are continuously formed to be opposed to the light-emitting element led. On the inner sides of the ridge sections 31, the U-shaped grooves 32 are continuously formed along the circumferential direction. Therefore, the U-shaped grooves 32 are arranged to be opposed to the plurality of light-emitting elements led. The plurality of light-emitting elements led are housed in the U-shaped grooves 32 and covered. Further, the flat section 33 extending in the width direction is formed from the ridge sections 31, and the entire surface of the substrate 21a is made covered by this.

With the lens member configured as explained above, lights emitted from the plurality of light-emitting elements led are diffused and radiated mainly in the inner circumferential direction and the outer circumferential direction on the circumference by the ridge sections 31. That is, the lights emitted from the light-emitting elements les are diffused and radiated mainly in the radial direction centering on the center of the circle shape in a place where the light-emitting elements led are arranged.

Therefore, evenness of irradiated lights by the lights emitted from the plurality of light-emitting elements led can be improved by the lens member. Further, granularity due to the brightness of the light-emitting elements led can be suppressed. In the diffusing member 3, the flat section 33 is formed to cover the entire surface of the substrate 21a. Therefore, a charging section is covered and protected by the diffusing member 3.

The diffusing member 3 does not have to be integrally formed in the substantially circular shape. For example, the diffusing member 3 may be formed to be divided to correspond to each of the divided substrates 21a. In this case, each of the plurality of light-emitting elements mounted on one substrate 21a are continuously covered by the diffusing member 3. The diffusing member 3 is not limited to the lens member. A diffusing sheet or the like may be applied as the diffusing member 3.

In the light-emitting device 100 configured as explained above, as representatively shown in FIGS. 4 and 5, the substrate 21a is located around the attaching section 6 and a mounting surface for the light-emitting elements led is disposed to face the front surface side, i.e., in a downward irradiation direction. The rear surface side of the substrate 21a is attached in surface contact with the flat section 12a on the inner surface side of the luminaire main body 1a to be closely attached to the flat section 12a. Specifically, the diffusing member 3 is placed over the substrate 21a from the front surface side of the substrate 21a. The diffusing member 3 is attached to the luminaire main body 1a by fixing means such as the screws S, whereby the substrate 21a is held between the luminaire main body 1a and the diffusing member 3 and pressed and fixed. That is, the substrate 21a and the diffusing member 3 are tightened together by one screw S.

Therefore, the substrate 21a is thermally coupled to the luminaire main body 1a. Heat from the substrate 21a is conducted from the rear surface side to the luminaire main body 1a and radiated. The surface contact of the substrate 21a and the luminaire main body 1a is not limited to the contact of the entire surface of the substrate 21a with the luminaire main body 1a. The surface contact may be partial surface contact.

In addition, the flat section 33 in the diffusing member 3 is in surface contact with the mounting surface side of the substrate 21a to be closely attached to the mounting surface side. Therefore, heat from the mounting surface side of the substrate 21a can be conducted to the diffusing member 3 and radiated through the diffusing member 3. That is, the heat can be radiated from the front surface side of the substrate 21a as well.

As shown in FIGS. 2 to 4, the lighting circuit 4 includes the circuit board 41 and the circuit components 42 such as a control IC, a transformer, and a capacitor mounted on the circuit board 41. The circuit board 41 is formed in a substantially arcuate shape to surround the attaching section 6. The adapter A side of the circuit board 41 is electrically connected. The circuit board 41 is connected to the commercial alternating-current power supply via the adapter A. Therefore, the lighting circuit 4 receives the alternating-current power supply to generate a direct-current output and supplies the direct-current output to the light-emitting elements led via a lead wire to subject the light-emitting elements led to lighting control. The lighting circuit 4 is disposed between the attaching section 6 and the light-emitting device 100, i.e., the substrate 21a.

As shown in FIGS. 2 and 4, the lighting circuit cover 5 is formed in a substantially short cylindrical shape by a metal material such as cold rolled steel. The lighting circuit cover 5 is attached to the luminaire main body 1a to cover the lighting circuit 4. The sidewall 51 is formed in an inclined shape to expand toward the rear surface side. In the front wall 52, the opening section 53 is formed to correspond to the attaching section 6. Therefore, a part of the lights emitted from the light-emitting elements led is reflected to the front surface side by the sidewall 51 and effectively used. The guide concave section 54 having an arcuate shape concave to the rear surface side is formed at the circumferential edge of the opening section 53.

The attaching section 6 is an adapter guide formed in a substantially cylindrical shape. In the center of the adapter guide, the engaging opening 61 through which the adapter A is inserted and with which the adapter A engages is provided. The adapter guide is disposed to correspond to the opening 11a formed in the center of the luminaire main body 1a. In the outer circumferential portion of the adapter guide, a base is formed to project from the outer circumferential portion. The electric auxiliary components 62 such as an infrared remote control signal receiving section and an illuminance sensor are disposed on the base.

The attaching section 6 does not always have to be a member referred to as adapter guide. For example, the attaching section 6 may be an opening formed in the luminaire main body 1a or the like. In short, the attaching section 6 means a member or a section that is opposed to the ceiling hook body Cb functioning as the wiring device and with which the adapter A is engaged.

The cover member 7 is formed in a substantially circular shape from a material having translucency and diffusibility and colored in milky white such as acrylic resin. The decorative cover 71 of non-light-transmissive and a circular shape is attached to the center of the cover member 7. In the decorative cover 71, the light-receiving window 72 having a substantially triangular shape and light-transmissive is formed to be opposed to the electric auxiliary components 62. Further, the projecting pin 73 projecting in the inner surface direction is formed closer to the center on the inner surface side of the cover member 7.

The cover member 7 is detachably attached to the outer circumferential edge of the luminaire main body 1a to cover the front surface side of the luminaire main body 1a including the light-emitting device 100. Specifically, if the cover member 7 is pivoted, the cover attachment fitting 74 provided in the cover member 7 is engaged with the cover receiving fitting 75 disposed in the concave section 14a in the step section 13a in the outer circumferential portion of the luminaire main body 1a, whereby the cover member 7 is attached. If the cover member 7 is detached, the cover member 7 is pivoted in a direction opposite to a direction during the attachment to disengage the cover attachment fitting 74 and the cover receiving fitting 75, whereby the cover member 7 can be detached.

In a state in which the cover member 7 is attached to the luminaire main body 1a, as mainly shown in FIG. 5, the inner surface side of the cover member 7 is in surface contact with the front wall 52 of the lighting circuit cover 5. Therefore, it is possible to conduct heat generated from the lighting circuit 4 or the like to the lighting circuit cover 5, further conduct the heat to the cover member 7, and facilitate thermal radiation.

The cover member 7 is pivoted to be attached to the luminaire main body 1a. However, it is necessary to align the position of the light-receiving window 72 to be opposed to the electric auxiliary components 62. Therefore, in this embodiment, although not explained in detail, position regulating unit is configured by the projecting pin 73 formed on the cover member 7 side and the guide concave section 54 formed in the lighting circuit cover 5. The light-receiving window 72 is located to be opposed to the electric auxiliary components 62 by the position regulating unit. For example, the infrared remote control signal receiving section can receive a control signal from an infrared remote control transmitter.

The adapter A is electrically and mechanically connected to the ceiling hook body Cb, which is set on the ceiling surface C, by a hooking blade provided on the upper surface side of the adapter A and is formed in a substantially cylindrical shape. A pair of locking sections A1 is provided on both sides of a circumferential wall of the adapter A to be always projected to the outer circumferential side by springs incorporated in the locking sections A1. The locking sections A1 are retracted by the operation of a lever provided on the lower surface side of the adapter A. A power supply cord connected to the lighting circuit 4 is led out from the adapter A. The adapter A is connected to the lighting circuit 4 via a connector (see FIG. 3).

An attachment state of the luminaire 200 to the ceiling surface C is explained with reference to FIG. 8. First, the adapter A is electrically and mechanically connected to the ceiling hook body Cb set on the ceiling surface C in advance. From this state, while the engaging opening 61 of the adapter guide functioning as the attaching section 6 is aligned with the adapter A, the luminaire main body 1a is pushed up by hand resisting the elasticity of the spring member 15a for attaching the luminaire 200 until the locking sections A1 of the adapter A surely engage with the engaging opening 61 of the adapter guide.

Subsequently, the cover member 7 is attached to the luminaire main body 1a. If the cover member 7 is pivoted, the cover attachment fitting 74 provided in the cover member 7 is engaged with the cover receiving fitting 75 of the luminaire main body 1a, whereby the cover member 7 is attached.

If the luminaire 200 is detached, the cover member 7 is detached and the lever provided in the adapter A is operated to disengage the locking sections A1 of the adapter A, whereby the luminaire 200 can be detached.

As explained above, the light-emitting device 100 or the luminaire 200 according to this embodiment includes the first light source section 1 including the m series circuits, in each of which the n light-emitting elements led for the N color are connected in series, the m series circuits being connected in parallel to one another, and the second light source section 2 including the m series circuits, in each of which the n light-emitting elements led for the L color are connected in series, the m series circuits being connected in parallel to one another. The light-emitting elements of the series circuits different from one another of the light source sections different from each other are mounted on the substrate 21a adjacent to one another. Therefore, it is possible to provide the light-emitting device 100 or the luminaire 200 in which brightness fluctuation of the light-emitting circuit 100 or the luminaire 200 is suppressed without using balancing resistors in the series circuit in which the n light-emitting elements led are connected in series.

In the attachment state of the lamination 200 to the ceiling surface C, if electric power is supplied to the lighting circuit 4, the light-emitting elements led are lit. Lights emitted from the light-emitting elements led are diffused in the radial direction by the diffusing member 3, which continuously cover the plurality of light-emitting elements led, and radiated to the front surface side. The lights radiated to the front surface side are diffused by the cover member 7 and transmitted through the cover member 7 to be irradiated outward. Therefore, it is possible to improve evenness of the irradiated lights and suppress granularity due to the brightness of the light-emitting elements led. A part of the lights traveling to the inner circumferential side in the radial direction is reflected to the front surface side by the inclined sidewall 51 in lighting circuit cover 5 and effectively used.

The rear surface side of the substrate 21a is thermally coupled to the luminaire main body 1a. Therefore, heat is effectively conducted to the luminaire main body 1a and radiated in a wide area of the luminaire main body 1a. The step section 13a is located along the outer circumference of the substrate 21a in the vicinity of the outer circumferential side of the substrate 21a. Therefore, it is possible to increase a thermal radiation area using the step section 13a and improve a thermal radiation effect in the outer circumferential portion of the luminaire main body 1a.

The lighting circuit 4 is disposed between the attaching section 6 and the substrate 21a. Therefore, thermal influence on the lighting circuit 4 from the substrate 21a is reduced. This is because heat of the substrate 21a tends to be conducted in the outer circumferential direction of the luminaire main body 1a and radiated.

Further, the cover member 7 is set in surface contact with the lighting circuit cover 5. Therefore, it is possible to conduct heat generated from the lighting circuit 4 to the lighting circuit cover 5, further conduct the heat to the cover member 7, and radiate the heat.

In addition, the flat section 33 in the diffusing member 3 is in surface contact with the mounting surface side of the substrate 21a. Therefore, it is possible to conduct the heat from the mounting surface side of the substrate 21a through the diffusing member 3 and radiate the heat from the front surface side as well. In this case, since the diffusing member 3 covers the entire surface of the substrate 21a, the charging section is protected.

The invention is not limited to the configurations of the embodiments explained above. Various modifications are possible without departing from the spirit of the invention. For example, a solid-state light-emitting element such as a LED or an organic EL can be applied as the light-emitting element led. In this case, the number of the light-emitting elements led is not specifically limited. The luminaire 200 can be applied to various luminaires 200 used indoor or outdoor, a display apparatus, and the like.

In the embodiments, the light-emitting elements selected from mutually different series circuits are mounted adjacent to one another. Fluctuation in characteristics of the light-emitting elements due to temperature distribution of the substrate uniformly acts on the series circuits. Therefore, it is possible to suppress brightness fluctuation of the light-emitting circuit and the luminaire.

In FIG. 6, an arc of 180 degrees of one circle of a double circle is explained. However, the other three arcs can be configured the same. These arcs can be connected to one another in series or in parallel to be connected to a power supply having two terminals. Besides the light-emitting circuits in which cool white and warm white are combined, light-emitting elements of the series circuits different from one another may be mounted adjacent to one another with respect to a light source having a single color. In the embodiments, the light-emitting elements having the same potential are mounted adjacent to one another in the series circuits different from one another such that the light-emitting elements are arranged from the high potential to the low potential in the series circuits different from one another. However, if desired, the light-emitting elements having potentials different from one another may be arranged adjacent to one another in the series circuits different from one another. In FIGS. 6 and 7, the light-emitting elements for cool white and the light-emitting elements for warm white may be selected from the respective series circuits in order from the high potential side and in order from the low potential side and arranged adjacent to one another, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting device comprising:
a light source section including a plurality of series circuits, in each of which a plurality of light-emitting elements are connected in series, the plurality of series circuits being connected in parallel; and
a substrate on which the light-emitting elements of the light source section are mounted, wherein
the light-emitting elements of the series circuits different from one another are mounted adjacent to one another.

2. The device according to claim 1, wherein
the light source section includes:
a first light source section including a plurality of series circuits, in each of which a plurality of light-emitting elements having a predetermined color temperature are connected in series, the plurality of series circuits being connected in parallel to one another; and
a second light source including a plurality of series circuits, in each of which a plurality of light-emitting elements having a color temperature different from the color temperature of the light-emitting elements of the first light source section are connected in series, the plurality of series circuits being connected in parallel to one another, and
the light-emitting elements of the series circuits different from one another of the light source sections different from each other are mounted adjacent to one another.

3. The device according to claim 1, wherein the light-emitting elements are mounted such that light-emitting elements of the series circuits different from one another are arranged adjacent to one another in order from the light-emitting element having high potential to the light-emitting element having low potential.

4. The device according to claim 1, wherein the substrate is divided into a plurality of substrates.

5. The device according to claim 1, wherein the light-emitting elements are mounted in a circular region.

6. The device according to claim 1, further comprising a diffusing member configured to diffuse lights of the light-emitting elements.

7. A luminaire comprising:
a luminaire main body; and
a light-emitting device disposed in the luminaire main body, wherein
the light-emitting device includes:
a light source section including a plurality of series circuits, in each of which a plurality of light-emitting elements are connected in series, the plurality of series circuits being connected in parallel; and
a substrate on which the light-emitting elements of the light source section are mounted, and
the light-emitting elements of the series circuits different from one another are mounted adjacent to one another.

8. The luminaire according to claim 7, wherein
the light source section includes:
a first light source section including a plurality of series circuits, in each of which a plurality of light-emitting elements having a predetermined color temperature are connected in series, the plurality of series circuits being connected in parallel to one another; and
a second light source including a plurality of series circuits, in each of which a plurality of light-emitting elements having a color temperature different from the color temperature of the light-emitting elements of the first light source section are connected in series, the plurality of series circuits being connected in parallel to one another, and
the light-emitting elements of the series circuits different from one another of the light source sections different from each other are mounted adjacent to one another.

9. The luminaire according to claim 7, wherein the light-emitting elements are mounted such that light-emitting elements of the series circuits different from one another are arranged adjacent to one another in order from the light-emitting element having high potential to the light-emitting element having low potential.

10. The luminaire according to claim 7, wherein the substrate is divided into a plurality of substrates.

11. The luminaire according to claim 7, wherein the light-emitting elements are mounted in a circular region.

12. The luminaire according to claim 7, further comprising a diffusing member configured to diffuse lights of the light-emitting elements.
